(19) United States
(12) Patent Application Publication
(10) Pub. No.: US 2024/0237628 A1
(43) Pub. Date: Jul. 18, 2024

(54) CONCEALED CATCH INSECT TRAP

(71) Applicant: David Bryan Gaskin, Tampa, FL (US)

(72) Inventor: David Bryan Gaskin, Tampa, FL (US)

(21) Appl. No.: 18/475,201

(22) Filed: Sep. 26, 2023

Related U.S. Application Data
(60) Provisional application No. 63/420,526, filed on Oct. 28, 2022.

(51) Int. Cl. A01M 1/14

(52) U.S. Cl. CPC A01M 1/14

(57) ABSTRACT

Concealed catch insect traps are described.

### RELATED APPLICATIONS

This application claims priority to U.S. Application No. 63/420,526, entitled “CONCEALED CATCH INSECT TRAP,” and filed on Oct. 28, 2022, which is incorporated herein by reference in its entirety.

### FIELD

Some implementations relate generally to insect traps, and, more particularly, to concealed catch insect traps for insects such as roaches and others.

### BACKGROUND

Some insects, such as German cockroaches (Blattella germanica) may be especially difficult to eradicate from a residential or commercial building. Some people and animals may be sensitive to pesticides and, accordingly, a non-pesticide insect control technique may be desired. Some conventional insect traps may be unsightly and/or may make trapped insects visible when in use.

Embodiments were conceived in light of one or more of the above-mentioned problems and limitations, among other things. The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

In some implementations, a concealed catch roach (or insect) trap is constructed to safely attract, catch, trap and hide multiple roaches in a concealed device that obscures the view of trapped roaches from the top side of trap. The concealed device serves as a vessel for roaches to enter through one or more holes (or ingress apertures, for example 6 holes) on the bottom of the trap which are out of view to the consumer (hence the title concealed catch). Once the roach has entered the trap, a (replaceable) glue board insert prevents the roaches from escaping, therefore trapping the roach until it dies. This device is meant to be used as an alternative to the use of harmful pesticides and sprays which makes it overall safer for the consumer and/or pest control professional to handle.

Some implementations of the concealed catch roach trap include a safe to use, enclosed trap that is nontoxic to humans and animals. The trap can be placed in a multitude of structures from hospitals, nursing homes, restaurants, schools, residential homes, commercial buildings, daycares, automobiles, stores, aircrafts, cruise ships, barges, shipping containers, warehouses, food establishments, section 8 housing, government buildings, essentially anywhere roaches may be present. The pest control industry would greatly benefit from use of this trap as a safe and effective tool to aid in controlling large infestations of roaches (specifically German roaches). The concealed catch roach trap is a safer/nontoxic alternative in controlling and helping stop the spread of roaches. This device allows the pest control professional to monitor and treat infestations more efficiently.

In some implementations, the concealed catch roach trap is re-usable and 100% recyclable. Because of the unique design of the trap, it permits roaches to easily enter through the 6 bottom holes of the trap. However, once the roach enters it will be trapped inside by the glue board insert. Once the roaches are trapped, they cannot escape, nor can you see the roach inside the trap as the top is made with a colored plastic that is non-translucent. It has been proven to drastically reduce large roach infestations. In some implementations, the concealed catch roach trap attracts, catches and traps roaches throughout all life cycle phases including adults, instars as well as babies. This allows the life cycle of the roach to be disrupted and considerably slows down the roach's ability to breed rapidly.

An implementation of the enclosed trap disclosed herein can be placed on multiple surfaces where roaches harbor and hide such as behind refrigerators, behind and under stoves, dishwashers, counter tops, next to garbage cans. Concealed catch can also be used outdoors, for example around the base of a structure, grilling areas, garages, shed, or anywhere that roaches or other insects may harbor.

In some implementations, the concealed catch roach trap is simple to use, is pesticide free, has easy to follow installation instructions and is 100% safe for consumers or professionals to handle. The concealed catch roach trap has also been shown to interrupt the life cycle of the German roach by subsequently catching and trapping pregnant females and their egg sacs on the glue surface, which eliminates the opportunity for the hatchlings to start a new breeding cycle.

In some implementations, the concealed catch roach trap is an effective tool for use in food establishments or any business that is regulated by the Health Department due to the discrete nature of its trapping and concealing ability.

The concealed catch roach trap is unique in that it is re-usable. Simply replace the glue board insert the roaches are trapped on, throw away the used glue board insert and replace it with a new one. This trap is 100% recyclable, completely safe to use and handle. The concealed catch roach trap is 100% pesticide free and safe to be around children, pets and food preparations without harm. This trap is made with colored (e.g., opaque or non-translucent) plastic which hides the trapped roaches from view. This feature is unique because the trap can be left out in the open without being able to see the trapped roaches inside therefore, consumers and businesses are not aware “visibly” that roaches are present. In some implementations, the concealed catch roach trap has (6) strategically placed entrance holes for roaches to enter into the bottom of the trap. These holes allow the roaches to easily access the trap without bunching together and in turn will ensure the full surface of the glue board insert to be utilized to its capacity. The trap also keeps the glue board insert active longer because it is fully enclosed which eliminates exposure to outside elements such as dust, dirt and other debris from sticking to it.

### BRIEF DESCRIPTION OF THE DRAWINGS

FIG. 1 is a diagram showing a front/top perspective view of an example concealed catch insect trap in accordance with some implementations.

FIG. 2 is a diagram showing a bottom perspective view of an example concealed catch insect trap in accordance with some implementations.

FIG. 3 is a diagram showing a bottom view of an example concealed catch insect trap in accordance with some implementations.

FIG. 4 is a diagram showing a side perspective view of an example concealed catch insect trap in accordance with some implementations.

FIG. 5 is a diagram showing an end view of an example concealed catch insect trap in accordance with some implementations.

FIG. 6 is a diagram showing a top view of an example concealed catch insect trap and glue board in accordance with some implementations.

FIG. 7 is a diagram showing a top view of an example concealed catch insect trap with glue board inserted in accordance with some implementations.

FIG. 8 is a diagram showing an end view of an example concealed catch insect trap with glue board inserted in accordance with some implementations.

FIG. 9 is a diagram of an example concealed catch insect trap having a top mounted hinged end piece in accordance with some implementations.

FIGS. 10A-10C are diagrams showing details of various hinge configurations in accordance with some implementations.

### DETAILED DESCRIPTION

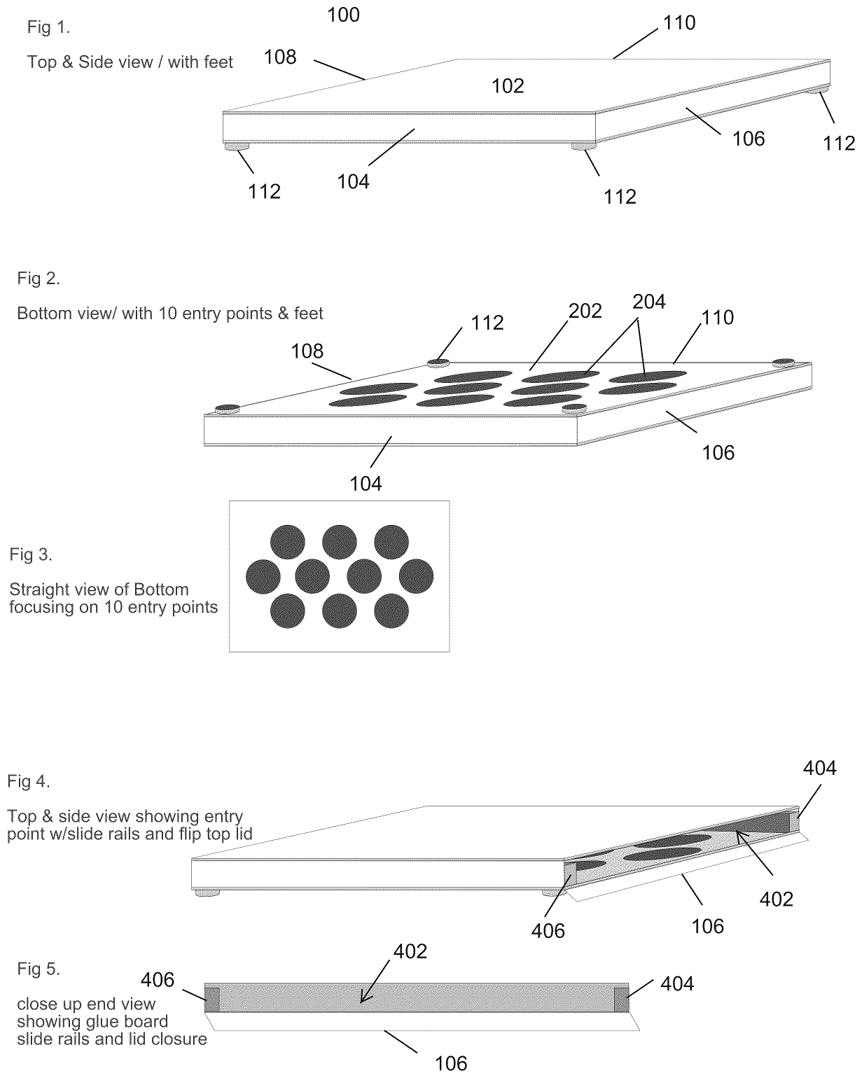

FIG. 1 is a diagram showing a front/top perspective view of an example concealed catch insect trap 100 in accordance with some implementations. The concealed catch insect trap 100 includes a top 102, a front side 104, a hinged first side 106, a second side 108, a back side 110, and one or more optional feet 112.

The optional feet 112 can include an elastomeric material that can be adhesive or non-adhesive. The optional feet 112 can be formed from a double-sided foam tape or similar material. The optional feet 112 can also be formed from a temporary adhesive material similar to that used in the Command™ line of adhesive products.

FIG. 2 is a diagram showing a bottom perspective view of an example concealed catch insect trap 110 in accordance with some implementations. The concealed catch insect trap 100 includes a bottom side 202 and one or more insect ingress apertures 204.

FIG. 3 is a diagram showing a bottom view of an example concealed catch insect trap 100 in accordance with some implementations.

FIG. 4 and are diagram showing side views of an example concealed catch insect trap 100 in accordance with some implementations. In particular, FIG. 4 shows the first hinged side 106 in a lowered position and a first side rail 404 and a second side rail 406. FIG. 5 shows an interior opening 502.

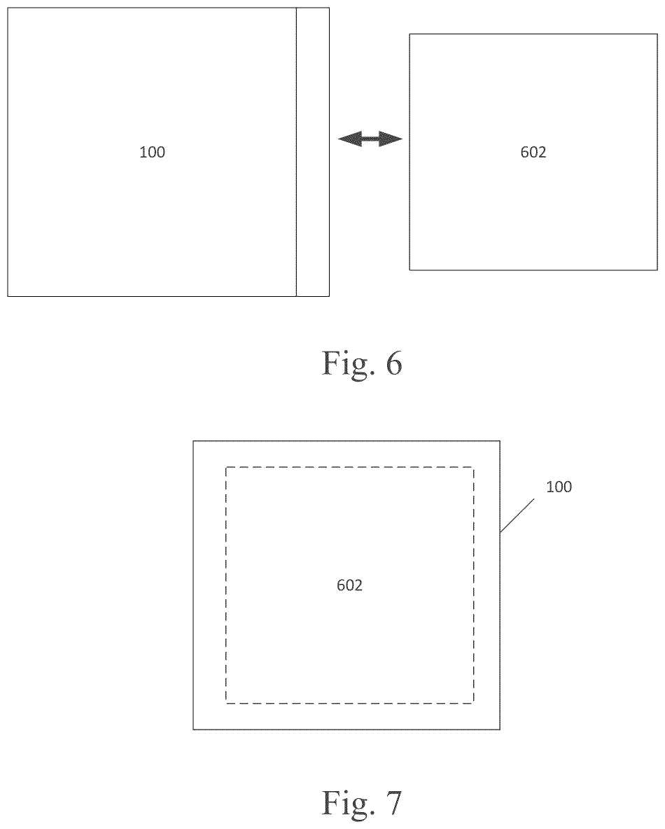

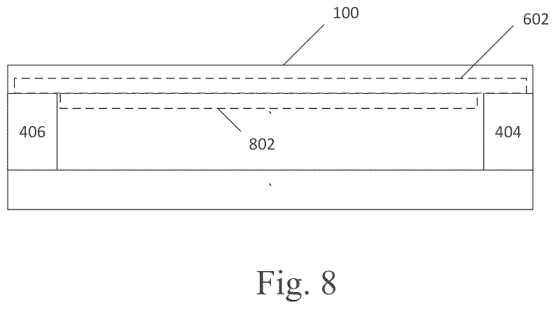

In operation, as shown in FIGS. 6-8, a glue board 602 is inserted into the concealed catch insect trap 100. The glue board can have a first side with adhesive 802 and a second side with no adhesive. Further, the glue board can have a boarder 804 on the first side where no adhesive is placed. This border can permit the glue board to be inserted into the concealed catch insect trap as shown in FIGS. 7 and 8.

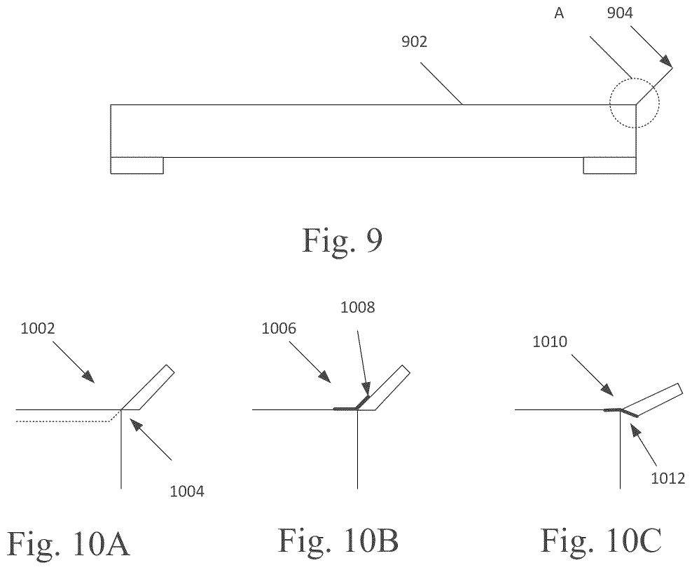

FIG. 9 is a diagram of an example concealed catch insect trap 902 having a top mounted hinged end piece 904 in accordance with some implementations. The hinge between 902 and 904 can include any one of a various type of hinges for plastic (or other material), such as:

1. Living hinges: Thin, flexible plastic sections that allow repeated bending without breaking.

2. Piano hinges: Long, continuous plastic hinges that run the entire length of a door or flap.

3. Snap-on hinges: Hinges that can be easily attached or detached without the need for tools.

4. Butt hinges: Standard hinges with two interlocking leaves that allow rotation.

5. Barrel hinges: Cylindrical hinges that provide rotational movement.

6. Invisible hinges: Concealed hinges that are not visible when the door or lid is closed.

Tape hinges that include pieces of flexible adhesive material. Discrete hinges that can be attached to the inside or outside of a movable piece.

Section A is shown in greater detail in FIGS. 10A-10C.

FIGS. 10A-10C are diagrams showing details of various hinge configurations in accordance with some implementations. In particular, FIG. 10A shows an example living hinge 1002 having a flexible portion 1004.

FIG. 10B shows an example exterior hinge 1004 having a tape or barrel hinge 1006 on an exterior surface.

FIG. 10C shows an example interior hinge 1008 having a tape or barrel hinge 1010 on an interior surface.

In some implementations, concealed catch roach traps can be placed anywhere for trapping and catching roaches. Some implementations can be safe to use and can be placed in obscure areas of a structure or can be placed in common areas out in the open. Trapped or dead roaches will not be viewable to the consumer from the top of the trap because of the uniquely colored plastic that hides them from view. This feature allows the trap to continue catching and trapping roaches for prolonged periods of time. Concealed catch insect traps are multi-functional in that they can be installed upside down, vertically, horizontally or sit on a flat surface such as a countertop. The trap can be placed in close proximity to infestations and is capable of safely catching hundreds of roaches throughout all life cycles before having to change out the glue board insert.

Once the glue board is inserted and the hinged side is moved to a closed position, the concealed catch insect trap can be placed on a horizontal surface (e.g., a counter, cabinet, etc.) or on a vertical surface (e.g., adhered to a wall). Insects, such as the German cockroaches enter the trap from the insect ingress apertures and become stuck on the glue side of the glue board

It will be appreciated that the concealed catch insect trap can vary in size depending on a contemplated implementation. Further, the size, shape and number of insect ingress apertures (e.g., 202) can vary according to a contemplated implementation. In some implementations, the concealed catch insect trap can be sized such that a glue board when plate (i.e., before being formed into a trap) can be inserted into the concealed catch insect trap.

For example, a concealed catch roach trap can measure 8¼″×5½″×⅝″ and can be a re-usable, recyclable, enclosed trap, which is safe for consumer use. The trap is designed to be used in conjunction with glue board inserts measuring 8×5. The colored plastic top makes the trap unique as it hides the trapped roaches from view, which allows this device to sit out in the open counters or be attached to a wall in plain view (e.g., using double sided tape, Command tape, heavy duty hook and loop fastener system for outdoor or indoor uses). The concealed catch roach trap attracts, catches and traps roaches throughout all life cycle phases including adults, instars as well as babies.

With the inability to view trapped roaches inside this device, it now becomes a perfect (or near perfect) roach catcher for multiple establishments who do not want to see dead or dying roaches in open view. This trap enclosure can be re-used multiple times, once the glue board insert is full, simply lift/flip enclosure lid into an open position, slide out the used glue board insert and discard it into the trash. A new glue board can be slid into place and the list/flap can be closed. The trap is now ready for another use.

After the old glue board insert has been discarded, Concealed Catch Roach Trap is now ready for a new glue board to be inserted. Simply insert a new 8×5 inch glue board insert into the alignment track of the Concealed Catch Roach Trap. The glue board insert will be inserted with the glue side facing the 6 holes on the bottom of the trap then close the lid to secure the glue board. The enclosed trap is now ready for use.

The concealed catch insect trap can be formed from plastic, metal, cardboard, wood, or any suitable material.

While some example implementations have been described in terms of a general embodiment with several specific example modifications, it is recognized that other modifications and variations of the embodiments described above are within the spirit and scope of the disclosed subject matter. Applicant intends to embrace any and all such modifications, variations and embodiments.

What is claimed is:

1. A concealed catch insect trap comprising:
a top side;
a front side connected along one edge to the top side, wherein the front side includes a first rail disposed on an interior of the front side and offset from the top side so as to create a gap between a top of the first rail and an interior surface of the top side;
a hinged first side;
a second side connected to the front side and the top side;
a back side connected along one edge to the top side, wherein the back side includes a second rail disposed on an interior of the back side and offset from the top side so as to create a gap between a top of the second rail and an interior surface of the top side; and
a bottom side connected along one each to each of the front side, the back side, and the second side, wherein the bottom side includes one or more insect ingress apertures.

2. The concealed catch insect trap of claim 1, wherein the hinged first side is connected to the top side.

3. The concealed catch insect trap of claim 1, wherein the hinged first side is connected to the bottom side.

4. The concealed catch insect trap of claim 1, further comprising one or more feet each disposed adjacent to an exterior corner of the bottom side.

5. The concealed catch insect trap of claim 4, wherein each of the one or more feet include a non-adhesive elastomeric material.

6. The concealed catch insect trap of claim 4, wherein each of the one or more feet include an adhesive elastomeric material.
